(19) United States
(12) Patent Application Publication
(10) Pub. No.: US 2013/0282285 A1
(43) Pub. Date: Oct. 24, 2013

(54) METHOD AND DEVICE FOR DETERMINING THE MOVEMENTS OF A FLUID FROM REMOTE MEASUREMENTS OF RADIAL VELOCITIES

(71) Applicants: Matthieu Boquet, Paris (FR); Maxime Nibart, Lagny Sur Marne (FR); Armand Albergel, Rueil Malmaison (FR)

(72) Inventors: Matthieu Boquet, Paris (FR); Maxime Nibart, Lagny Sur Marne (FR); Armand Albergel, Rueil Malmaison (FR)

(73) Assignee: Leosphere, Paris (FR)

(21) Appl. No.: 13/977,189

(22) PCT Filed: Dec. 28, 2011
(86) PCT No.: PCT/FR11/53200

§ 371 Date: Jun. 28, 2013

(30) Foreign Application Priority Data
Jan. 5, 2011 (FR) 1150057

(51) Int. Cl. G01P 5/00

(52) U.S. Cl. CPC G01P 5/00
USPC 702/3

(57) ABSTRACT

A method is provided for determining the flow of a fluid in a volume of interest, including steps of remotely measuring, at a plurality of measurement points distributed along at least three axes of measurement having different spatial orientations passing through the volume of interest, the radial velocity of the fluid in the vicinity of the measurement points, and for calculating the velocity of the fluid at a plurality of calculation points distributed in a grid in the volume of interest, wherein the calculation of the velocity of the fluid includes the use of a mechanical behavior model of the fluid. A device is disclosed for implementing the method.

### TECHNICAL FIELD

The present invention relates to a method for determining the movements of a fluid from remote measurements of radial velocities of movement of said fluid. It also relates to a device for the remote sensing of the movements of a fluid implementing said method.

The field of the invention relates more particularly to, but is not limited to, the remote sensing of the characteristics of the wind in the lower layers of the atmosphere.

### STATE OF THE PRIOR ART

Measurement of the movements of the atmosphere or of the wind is of considerable importance for many applications, in particular in meteorology and for the monitoring and characterization of sites such as airports and wind farms.

It is often useful to measure the displacement of air masses over a wide range of altitudes or in a zone corresponding to an extensive volume, which cannot be done with conventional anemometers such as cup anemometers, and requires remote sensing instruments, capable of taking remote measurements.

These instruments in particular include radar, lidar and sodar. Radar and lidar systems use electromagnetic waves, in hyperfrequency and optical frequency ranges respectively. Sodar systems use acoustic waves.

In particular there is the document by A. Dolfi-Bouteyre, M. Valla, B. Augère, J.-P. Cariou, D. Goular, D. Fleury, G. Canat, C. Planchat, T. Gaudo, L. Lombard, O. Petilon, J. Lawson-Daku, “1.5 μm all fiber pulsed lidar for wake vortex monitoring”, 14th Coherent Laser Radar Conference (CLRC XIV), Snowmass, Colo., USA, 8-13 Jul. 2007, which presents an example of implementation of lidar.

Measurements of the movement of air masses with such instruments are generally carried out as follows:
The apparatus transmits one or more beams of waves (acoustic and/or electromagnetic) along transmission axes in the zones to be measured, continuously or as pulses. The transmissions along the different transmission axes can be simultaneous or sequential.
The beams are subjected to scattering effects in the atmosphere, due in particular to the inhomogeneities encountered (aerosols, particles, variations in refractive indices for electromagnetic waves or in acoustic impedance for acoustic waves). When they are scattered in air masses or moving particles, these beams of waves also undergo a frequency shift by the Doppler effect.
The backscattered beams are detected by one or more receivers oriented according to measurement axes. These receivers detect the waves scattered by the atmosphere in their direction along their measurement axis.
The distance along the measurement axis of the detectors at which scattering occurred can then be calculated, for example by a method of measuring the time of flight, or a method of phase shift measurement by interferometry. The radial velocity of the air masses or particles along the measurement axis can also be obtained by measuring the frequency shift of the wave by the Doppler effect. This measured radial velocity corresponds to the projection of the velocity vector of the scattering site on the measurement axis of the detector.

Remote sensing instruments, including in particular lidar systems suitable for measuring the characteristics of the wind in the lower layers of the atmosphere, are often of the monostatic type. This signifies that the same optics or the same antenna (acoustic or electromagnetic) are used for transmission and for reception of the signal. The volume probed is generally distributed along a cone with its apex located at the level of the optics or of the antenna of the instrument. Each beam of pulses of the instrument along the cone measures the radial velocity of movement of the particles along a measurement axis that coincides with the transmission axis. Measures are thus obtained of the radial velocity of the wind, representative of the projection of the wind vector on the beam propagation axis.

The wind vector throughout all the volume of interest must then be calculated, on the basis of the measures of radial velocity obtained.

In existing devices, this calculation is generally carried out using purely geometric models. These models have the drawback that they are based on a hypothesis that is sometimes rather unrealistic, in particular spatial and temporal homogeneity of the wind for the whole duration of measurement of the sample. According to this hypothesis, at a given altitude the wind vector is identical at every point of the atmosphere probed by the instrument.

It is known, for example, to calculate the components of the wind vector at a given altitude from at least three measures of radial velocities measured at one and the same altitude in at least three different directions, by solving a system of at least three equations with three unknowns that describes the geometric relationship between the wind vector and its projections along the axes of measurements constituted by the measurements of radial velocities.

A method is known for geometric calculation, described in the literature under the name “Velocity Azimuth Display” (VAD), which is also based on the hypothesis of spatial homogeneity of the wind at a given altitude. This method is applicable if the device allows measurements to be taken in directions covering the whole of a measurement cone. It consists of a parametric optimization for the horizontal velocity, the direction and the vertical velocity, exploiting the fact that all of the radial velocities measured in a complete revolution (360 degrees) of the measurement cone assume the form of a harmonic function. This method is in particular employed for processing measures obtained with lidar systems.

Document U.S. Pat. No. 4,735,503 by Werner et al. is known, which describes a method derived from said VAD method, according to which acquisition can be limited to angular sectors. However, this method is based on the same hypotheses of spatial homogeneity of the wind at a given altitude.

The atmospheric remote sensing instruments for wind measurement using geometric techniques for reconstruction of the wind vector allow precise measurement of the average velocity of the wind when the measurement is carried out above essentially flat terrain (terrain with very little or no undulation, or offshore). For example, with lidar systems, relative errors obtained for measures averaged over 10 minutes are under 2% relative to the reference constituted by calibrated cup anemometers.

On the other hand, the accuracy of determination of the horizontal and vertical velocity deteriorates considerably when the measurement is carried out above more complex terrains such as undulating or mountainous terrains, terrains covered with forest, etc. A relative error for average values calculated over 10 minutes of the order of 5% to 10% was observed on complex sites, for measurements carried out with these same lidar systems and relative to a calibrated cup anemometer.

The current telemetry devices implementing geometric models therefore do not allow sufficiently accurate measurement of horizontal and vertical velocity, and direction of the wind over complex terrain. In fact, in this particular instance, the wind can no longer be considered to be homogeneous at a given altitude in the volume of atmosphere probed by the instrument. Now, accurate measurements of the characteristics of the wind are essential under these conditions, in particular in the context of the development of wind farms.

This limitation also appears when investigating the wind profile as a function of altitude, i.e. the velocity vector of the wind as a function of altitude directly above the instrument.

The purpose of the present invention is to propose a method for determining the movements of a fluid applicable to measurement of the movement of air masses in complex environments.

### DISCLOSURE OF THE INVENTION

This objective is achieved with a method for determining the flow of a fluid in a volume of interest, comprising steps of:
remote measurement, at a plurality of measurement points distributed along at least three measurement axes with different spatial orientations passing through the volume of interest, of the radial velocity of said fluid in the vicinity of said measurement points,
calculation of the velocity of the fluid at a plurality of calculation points distributed as a grid in the volume of interest,
characterized in that calculation of the velocity of the fluid comprises the use of a mechanical behaviour model of said fluid.

Advantageously, measurement of the radial velocity of the fluid can comprise measurement of frequency shifts, due to the Doppler effect, of waves previously transmitted and scattered in the fluid.

The measurements of radial velocities can be carried out with all configurations of instruments, in particular monostatic instruments (with transmitters and receivers spatially coinciding), bistatic instruments (comprising transmitters and receivers spatially separate) or combinations of several instruments distributed over a site.

The method according to the invention is of course applicable to measurements in fluids of any type, in particular liquids or gases, in which measures of radial velocities can be obtained, and which can be described by a mechanical behaviour model.

It makes it possible to determine the movements of the fluid in a volume of interest from measures of radial velocities taken on a plurality of measurement axes, more accurately than the known geometric methods, in particular in cases when the behaviour of the fluid in the volume does not satisfy the hypothesis of spatial homogeneity necessary for the geometric models of the prior art.

This hypothesis can for example be stated as follows: The velocity vector that is representative of the local movement of the fluid is substantially identical for all the points of the volume of interest located at distances that are substantially equivalent relative to a reference such as the sensor. It often proves rather unrealistic in practice.

The use of a model of behaviour of the fluid makes it possible to describe behaviour that is far more complex. Measurement of the components of the velocity vector of the fluid can thus be greatly improved, in particular in complex and/or perturbed environments.

Advantageously, the method according to the invention is intrinsically three-dimensional, in the sense that it directly supplies a three-dimensional representation of the velocity vector of the wind in a volume. Moreover, provided the measurements of radial velocities are carried out along measurement axes with spatial orientations judiciously distributed relative to the volume of interest, the components of the velocity vector of the fluid are all determined with comparable accuracy, with no particular distinction between, for example, horizontal and vertical components.

The volume of interest can be delimited or defined by a grid connecting the calculation points. This grid can comprise meshes that are structured (Cartesian grid for example of rectangular or curvilinear section) or unstructured. The measurement points can be included in the volume of interest and in the grid.

The method according to the invention can further comprise a step of calculating initialization conditions, comprising a calculation of the velocity of the fluid at calculation points from measures of radial velocities, using a geometric model based on the hypothesis that the velocity of the fluid in the volume of interest is substantially homogeneous in layers with substantially parallel orientation through which the measurement axes pass, said calculation of initialization conditions comprising at least one of:
a calculation of boundary conditions comprising a calculation of conditions that are limiting for the velocity (or velocity vector) of the fluid at calculation points located at the periphery of the volume of interest, and
a calculation of initial conditions comprising a calculation of the velocity of the fluid at calculation points located in the volume of interest.

Defining, in the volume of interest, a Cartesian coordinate system (X, Y, Z) in which the Z axis defines the altitude, the homogeneous layers can for example be oriented substantially parallel to the planes (X, Y).

The method according to the invention can further comprise a step of calculating initialization conditions using the topology of a material surface present in or at the periphery of the volume of interest and limiting the extension of the fluid, comprising:
a determination of calculation points of the volume of interest located outside of the fluid and/or in the vicinity of said material surface, and
an attribution of conditions limiting for the velocity (or the velocity vector) to said defined calculation points.

This initialization condition can take account of the relief of a surface that is present and affects the flow of the fluid. The material surface can be for example that of a terrain located at the base of the volume of interest, the topology of which would have been determined beforehand. In order to be able to apply this initialization condition, the volume of interest and its grid are then defined so that said surface is included totally or partially.

The method according to the invention can further comprise a step of calculating the velocity (or velocity vectors) of the fluid in the volume of interest, by solving the equations of the mechanical behaviour model of the fluid, using the initialization conditions calculated previously.

Only the initialization conditions, comprising the boundary conditions and the initial conditions, are calculated on the basis of a hypothesis of spatial homogeneity. They constitute the starting point of the calculation of the velocity of the fluid in the volume of interest:
the boundary conditions make it possible to create a constraint on the velocity of the fluid at the periphery of the volume of interest, so that solving the equations of the mechanical behaviour model of the fluid leads to a defined solution in the volume of interest;
the initial conditions make it possible to initialize solving the equations of the mechanical behaviour model of the fluid by an iterative method, so as also to converge towards a defined solution.

In the context of the invention it is possible to implement all models of mechanical behaviour of the fluid. The choice of the model can advantageously be adapted depending on the context, in order to optimize the complexity of the calculations.

According to embodiments, the mechanical behaviour model of the fluid can comprise the hypotheses that the fluid comprises an incompressible Newtonian fluid and that its flow can be described approximately by the Navier-Stokes equations.

The Navier-Stokes equations, according to a usual manner of representation, can comprise a continuity equation and a balance equation of the amount of movement.

According to embodiments, the mechanical behaviour model of the fluid can comprise the hypotheses that the flow of the fluid is stationary.

According to other embodiments, the mechanical behaviour model of the fluid can comprise the hypothesis that the fluid comprises a perfect fluid and that its flow can be described approximately by the Euler equation of fluids.

In this case, compared with an incompressible Newtonian fluid, the effects of viscosity and the thermal gradients are also ignored.

A Newtonian fluid is a fluid the viscous stress tensor of which is a linear function of the strain tensor. This model applies well to many usual fluids, including in particular air and water.

The following variables are defined, with units expressed in the SI system:

\vec{V}: velocity vector of the fluid (normally in m·s⁻¹);

v: kinematic viscosity of the fluid (m²·s⁻¹);

ρ: density of the fluid (kg·m⁻³);

\vec{f}: resultant of the body forces exerted in the fluid (N·kg⁻¹);

p: pressure of the fluid (Pa).

The flow can then be described by a system of equations comprising an equation of conservation of mass and an equation of conservation of momentum such that:

$$\{ \begin{matrix}\vec{∇} \cdot \vec{V} = 0 \\ \frac{\partial \vec{V}}{\partial t} - v {∇}^{2} \vec{V} + ( \vec{V} \cdot \vec{∇} ) \vec{V} + \frac{1}{ρ} \vec{∇} p = \vec{f}\end{matrix} \qquad ( Eq . 1 )$$

where \vec{∇} is the nabla operator, \vec{∇}·\vec{V} is the divergence of the velocity vector \vec{V}, ∇²\vec{V} is the vectorial Laplacian of the velocity vector \vec{V} and \vec{∇}p is the gradient of the pressure p. The system of equations (Eq. 1) corresponds to the Navier-Stokes equations for a non-stationary incompressible fluid.

It is sometimes possible, for example when the fluid under consideration is air and the volume of interest is located in the lower layers of the atmosphere, to consider that the flow is stationary and that \vec{f}≈\vec{0}. The system of equations describing the flow of the fluid then becomes:

$$\{ \begin{matrix}\vec{∇} \cdot \vec{V} = 0 \\ - v {∇}^{2} \vec{V} + ( \vec{V} \cdot \vec{∇} ) \vec{V} + \frac{1}{ρ} \vec{∇} p = \vec{0}\end{matrix} \qquad ( Eq . 2 )$$

The system of equations (Eq. 2) corresponds to the equations of the boundary layer for a stationary incompressible fluid.

We can choose to ignore the effects of viscosity in equation 2, in which case we obtain a representation of the Euler equations of perfect fluids:

$$\{ \begin{matrix}\vec{∇} \cdot \vec{V} = 0 \\ ( \vec{V} \cdot \vec{∇} ) \vec{V} + \frac{1}{ρ} \vec{∇} p = \vec{0}\end{matrix} \qquad ( Eq . 3 )$$

The system of equations (Eq. 3) corresponds to the equations of the limit layer for a stationary, incompressible non-viscous fluid.

It is also possible to employ a model described only by the equation of conservation of mass, if the fluid can simply be considered as incompressible:

\vec{∇}·\vec{V}=0. (Eq. 4)

The equation (Eq. 4) describes the flow of a stationary, non-rotational, incompressible perfect fluid.

To summarize, according to these embodiments, with \vec{V} the velocity vector of the fluid, v the kinematic viscosity of the fluid, ρ the density of the fluid, \vec{f} the resultant of the body forces exerted in the fluid and p the pressure of the fluid, the flow of said fluid (considered to be incompressible and stationary) can be described by any one of the systems of equations:

$$\begin{matrix}- \{ \begin{matrix}\vec{∇} \cdot \vec{V} = 0 \\ \frac{\partial \vec{V}}{\partial t} - v {∇}^{2} \vec{V} + ( \vec{V} \cdot \vec{∇} ) \vec{V} + \frac{1}{ρ} \vec{∇} p = \vec{f} ;\end{matrix} & ( Eq . 5 ) \\ - \{ \begin{matrix}\vec{∇} \cdot \vec{V} = 0 \\ - v {∇}^{2} \vec{V} + ( \vec{V} \cdot \vec{∇} ) \vec{V} + \frac{1}{ρ} \vec{∇} p = \vec{0} ;\end{matrix} & ( Eq . 6 ) \\ - \{ \begin{matrix}\vec{∇} \cdot \vec{V} = 0 \\ ( \vec{V} \cdot \vec{∇} ) \vec{V} + \frac{1}{ρ} \vec{∇} p = \vec{0} ;\end{matrix} & ( Eq . 7 ) \\ - \vec{∇} \cdot \vec{V} = 0. & ( Eq . 8 )\end{matrix}$$

These equations for the partial derivatives of the mechanical behaviour model of the fluid can be solved numerically at the calculation points of the volume of interest by a finite difference method, in which the derivatives are approximated for numerical solving by finite differences.

The equations can thus be solved numerically at the calculation points of the volume of interest by an iterative method, for example of the prediction-correction type or constrained minimization (augmented Lagrangian or conjugate gradient), using the boundary conditions and the initial conditions defined and calculated beforehand.

Solving these equations of the mechanical behaviour model can comprise the use of conditioning matrices.

These conditioning matrices can improve the convergence of the solution and/or the stability of the algorithm and/or decrease the boundary effects.

The equations with partial derivatives of the mechanical behaviour model of the fluid can also be solved numerically at the calculation points of the volume of interest by other methods such as finite volumes, finite elements or a spectral method.

According to other embodiments, the mechanical behaviour model of the fluid can comprise the hypotheses that the fluid comprises a perfect fluid (i.e. a fluid whose viscosity is negligible), the flow of which is approximately irrotational in the volume of interest.

According to the law of conservation of mass, the divergence of the velocity vector \vec{V} of the fluid is then zero:

\vec{∇}·\vec{V}=0 (Eq. 9)

If it is further assumed that the flow is irrotational, it follows that the rotational of the velocity vector \vec{V} of the fluid in the volume of interest is zero, and therefore that there is a velocity potential P describing the fluid. This is called flow at velocity potential. The Laplacian of P is zero and the velocity vector \vec{V} is the gradient of P.

Thus, with \vec{V} the velocity vector of the fluid and P a velocity potential, the flow of said fluid can be described by the system of equations:

$$\{ \begin{matrix}{∇}^{2} P = 0 \\ \vec{V} = - \vec{∇} P\end{matrix} \qquad ( Eq . 10 )$$

These equations of the mechanical behaviour model of the fluid can be solved numerically at the calculation points of the volume of interest by inversion of the matrix of the Laplacian.

The method according to the invention can further comprise steps of:
calculating new initialization conditions from the velocity of the fluid previously calculated in the volume of interest by solving the equations of the mechanical behaviour model of the fluid,
calculating the velocity of the fluid in the volume of interest, by solving the equations of the mechanical behaviour model of the fluid, using said new initialization conditions.

These steps can be repeated iteratively, using, at each iteration, initialization conditions calculated from the velocities obtained in the volume of interest in the preceding iteration. In fact, the initialization conditions calculated at the first iteration from the measures of radial velocities are distorted by the hypothesis of homogeneity necessary for the calculation at this moment. They are thus corrected during the next iterations.

The steps of the method according to the invention such as have been presented can be summarized in a temporal sequence composed of:
a step of measurement of the radial velocities along the measurement axes, and
a step of calculating the velocity vector in the volume of interest.

In this way a representation of the velocity vector in the volume of interest is obtained at the instant of the measurements, assuming a “motionless” or stationary environment, i.e. in which the temporal variations of the velocity of movement of the fluid over the time of the measurements are negligible. However, this hypothesis is not very limiting as it simply imposes a stationary state for the acquisition time of the measurements, or in other words that the environment varies slowly in the acquisition time. Now, even in the case of sequential measurements, this acquisition time can usually be limited to a few seconds.

In order to describe the behaviour of the fluid in the volume of interest over time, it is possible to implement a dynamic mechanical behaviour model of the fluid, i.e. a model that takes into account the temporal variation of the variables. Sequences of measurement and calculation can then be performed periodically over time, at rates compatible with the time constants of the phenomena to be observed. Solving the equations of the dynamic model for calculating the velocity of the fluid then requires the use of velocities calculated during sequences that are close together in time, in order to approximate the temporal derivatives.

Thus, the method according to the invention can further comprise at least one previous sequence of measurement of radial velocities and calculation of the velocity of the fluid in the volume of interest, and the calculation of the velocity of the fluid in the volume of interest can comprise the use of a dynamic mechanical behaviour model of the fluid, and the use of velocities of the fluid calculated during said previous sequence or sequences.

It should be noted that the temporal periodicity of the sequences is defined by the measurements. It is entirely equivalent, without any change in the definition of the sequence, to acquire the measures of a plurality or of all of the sequences, and subsequently calculate the velocities in the volume of interest for the whole time period covered by the measurements.

The method according to the invention can be implemented in all types of instruments suitable for measuring radial velocities of fluids along measurement axes, and in particular in instruments:
using acoustic and/or electromagnetic waves for performing the measurements;
performing measurements sequentially, or simultaneously along a plurality or all of the measurement axes used;
having a distributed architecture, with one or a plurality of separate transmitters and one or a plurality of separate receivers.

The method according to the invention can advantageously be implemented for measuring the wind in the lower layers of the atmosphere. It can advantageously be implemented, for example, in a device of the lidar, radar or sodar type.

According to another aspect of the invention, a device is proposed for determining the flow of a fluid in a volume of interest using the method according to any one of the preceding claims, comprising:
means for remote measurement, at a plurality of measurement points distributed along at least three measurement axes with different spatial orientations passing through the volume of interest, of the radial velocity of said fluid in the vicinity of said measurement points,
means for calculating the velocity of the fluid, at a plurality of calculation points distributed as a grid in the volume of interest,
characterized in that said means for calculating the velocity of the fluid are arranged for implementing a mechanical behaviour model of said fluid.

Advantageously, the device according to the invention can further comprise any one of the following devices: lidar, radar, sodar.

### DESCRIPTION OF THE FIGURES AND EMBODIMENTS

Other advantages and features of the invention will become apparent on reading the detailed description of implementations and embodiments, which are in no way limitative, and the following attached diagrams:

FIG. 1 shows a block diagram of a lidar,

FIG. 2 shows the relationship between the measured radial velocity and the velocity vector of the fluid,

FIG. 3 is an overall view of the volume of interest, with the grid and measurement axes,

FIG. 4 shows the grid of the volume of interest, along a section X-Y,

FIG. 5 presents an example of the result of calculating the velocity of the wind at a given altitude with the method according to the invention,

FIG. 6 shows an example of the result of calculating the profile of the wind as a function of the altitude, respectively with cup anemometers, a lidar using a method of geometric reconstruction and a lidar implementing the method according to the invention,

FIG. 7 shows results of the measurement of wind velocity obtained at one position over time respectively with a cup anemometer, a lidar implementing a method of geometric reconstruction and a lidar implementing the method according to the invention.

An embodiment of the method according to the invention in an atmospheric lidar will be described, for applications of measurement of the wind in the lower layers of the atmosphere.

According to this particular embodiment, which is in no way limitative, the fluid is air, the flow of which generates wind.

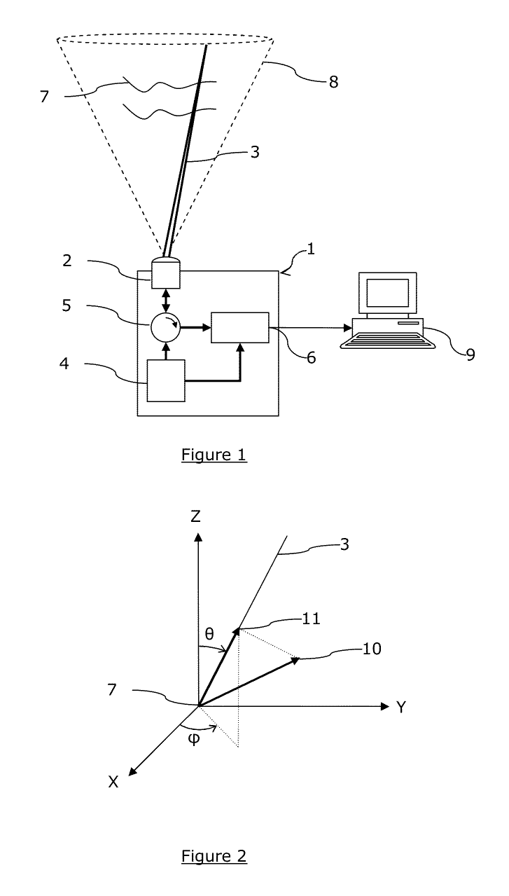

With reference to FIG. 1, the invention is implemented in a lidar 1 of monostatic configuration, such as presented for example in the document of A. Dolfi-Bouteyre et al., “1.5 μm all fiber pulsed lidar for wake vortex monitoring” cited above. This lidar comprises:
a source of light 4 with a pulsed fibre laser based on an architecture of the MOPFA (Master Oscillator Power Fibre Amplifier) type, which transmits linearly-polarized monochromatic light pulses with a wavelength of the order of 1.5 μm;
an orientable collimator 2 with collimation optics, which can transmit a measuring beam along a measurement axis 3 located in a measurement cone 8 with angle at the base of the order of 30°, and collect the light backscattered in the atmosphere by scattering centres 7 such as aerosols, particles or pollutants up to altitudes greater than 400 m;
a detection module 6, in which the backscattered light is mixed with the beam of a local oscillator originating from the source 4, so as to employ heterodyne detection;
a circulator 5 which transfers the light generated by the source 4 to the collimator 2, and the light collected by the collimator 2 to the detection module 6. This circulator is based on polarizing optical elements such as a polarizing beam separator and wave plates; and
a processing unit 9, for processing the measures.

The distance along the measurement axis 3 at which the backscattering of the beam by the scattering centres 7 takes place is obtained by measuring the round-trip time of the light pulses transmitted by the source 4 and detected by the detection module 6 after backscattering.

The movement of the scattering centres 7 produces a Doppler shift in the frequency of the backscattered wave, which is measured by heterodyne detection.

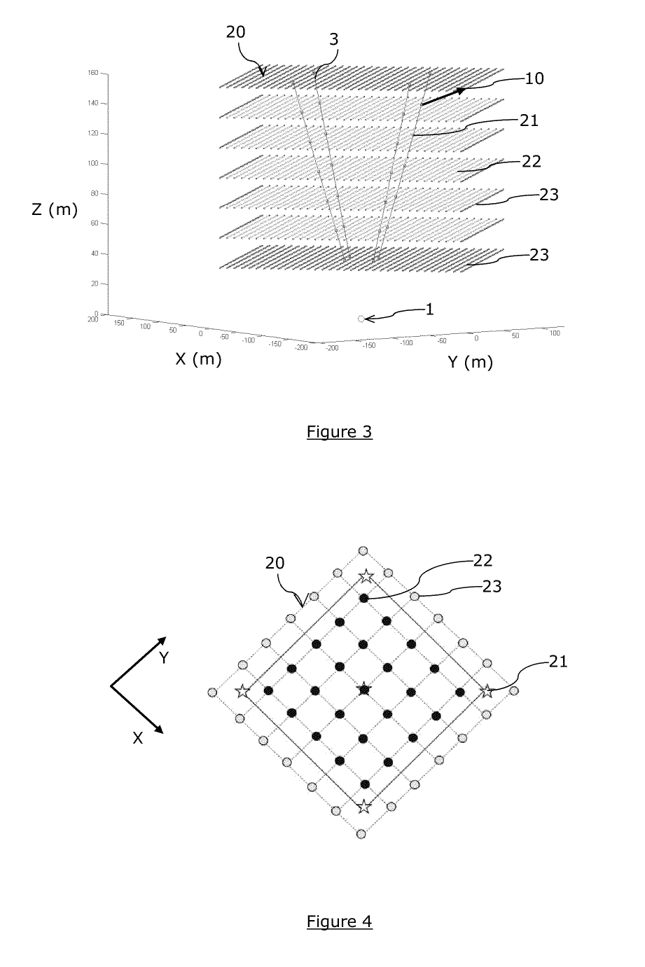

With reference to FIG. 2, the Doppler shift in the frequency of the backscattered wave is proportional to the radial velocity 11, i.e. the projection on the measurement axis 3 of the velocity of movement of the scattering centres 7, represented by the velocity vector 10.

The calculations of distance and of radial velocity 11 are carried out in the spectral domain, by means of Fast Fourier Transforms (FFT). The resolutions obtained for the distance and the radial velocity 11 are, respectively, of the order of some metres and of the order of some metres per second. The measurement time along a measurement axis 3 is of the order of one second.

With reference to FIGS. 3 and 4, the objective of the method according to the invention is to calculate the wind, represented by its velocity vector 10, in a volume of interest. This volume of interest is delimited by a grid 20 of calculation points 22 and 23 arranged as cubic meshes. A Cartesian coordinate system (X, Y, Z) whose Z axis defines the altitude is associated with the grid 20.

According to the method of the invention, the velocity vector 10 is calculated at a set of calculation points 22 of the grid 20, numerically solving the equations of a mechanical behaviour model of the fluid (in this case air), at the calculation points 22. This calculation requires the definition of initialization conditions, which can be obtained from at least three measurements of radial velocity 11 carried out along three measurement axes 3 with different orientations.

According to this embodiment, measurements are performed with the lidar 1 along four measurement axes 3 distributed for example according to the four cardinal directions, and with inclinations close to the limits of the measurement cone 8 of the instrument 1. A fifth measurement along a vertical axis can also be carried out. It is assumed, for carrying out the method according to the invention, that the atmosphere is stationary or motionless for the time necessary for acquisition of these four or five measures, i.e. the velocity vector of the wind 10 in the volume of interest is substantially constant at each point during this acquisition time. However, this hypothesis is not very restricting, since the total acquisition time can be much less than ten seconds.

For each measurement axis 3, the measures of radial velocities 11 are averaged at measurement points 21 corresponding to predetermined altitudes, generally equidistant. In order to simplify the calculations, altitudes are selected corresponding to the planes (X, Y), with Z constant, of the grid 20.

In order to calculate the boundary conditions at the periphery in the volume of interest, i.e. at the calculation points 23 located at the periphery of the grid 20, a classical geometric model is used, based on the hypothesis of spatial homogeneity of the wind at a given altitude, in the whole volume of interest.

Let \vec{V}=(Vₓ, V_{y}, V_{z}) be the velocity vector of the wind 10 expressed in the Cartesian coordinate system (X, Y, Z). According to the hypothesis of spatial homogeneity, the vector \vec{V} is assumed constant at any point of altitude Z=Zₕ and it is represented thus:

\vec{V}ₕ=(Vₓₕ,V_{yh},V_{zh}) (Eq.11)

As already explained, measurements are performed with the lidar 1 along K measurement axes 3 with different orientations marked with an index k, with k=1 . . . K; K≧3. According to the conventions of FIG. 2, the angles that define the orientation of the measurement axis 3 of index k are designated φₖ and θₖ.

From the measures, the radial velocity is calculated at measurement points 21 located along the measurement axes 3. Using Wₖₕ to denote the radial velocity at the measurement point of altitude Z=Zₕ located along the measurement axis k, we have:

Wₖₕ=Vₓₕ cos(φₖ)sin(θₖ)+V_{yh} sin(φₖ)sin(θₖ)+V_{zh} cos(θₖ), (Eq.12)

with k=1 . . . K.

We thus obtain a system of K equations with three unknowns (Vₓₕ, V_{yh}, V_{zh}), which can be solved within the meaning of the least squares to obtain \vec{V}ₕ.

Then the value \vec{V}ₕ is assigned to all the peripheral points 23 of the grid 20 located at an altitude Z=Zₕ, and this operation is performed for all the altitudes Z, directly or by interpolation between calculated values of \vec{V}ₕ.

The boundary conditions for all of the points 23 located at the periphery of the grid 20 are thus defined.

The next step consists of solving the equations of the selected mechanical behaviour model of the fluid at the calculation points 22, taking into account the boundary conditions defined on the basis of the measurements. Solving these equations is carried out by a numerical method suitable for the equations selected.

Experience has shown that in this embodiment devoted to analysis of the movements of the atmosphere, satisfactory results are obtained regarding air as a perfect fluid (i.e. a fluid whose viscosity is negligible), the flow of which is irrotational in the volume of interest. This choice has the advantage of leading to a numerical model, which can be solved more simply. This confers notable advantages in terms of resources required and calculation time.

According to this model, as demonstrated above, there is a velocity potential P that describes the fluid (air), and the flow (the wind) can be described by the system of equations:

$$\{ \begin{matrix}{∇}^{2} P = 0 \\ \vec{V} = - \vec{∇} P\end{matrix} \qquad ( Eq . 13 )$$

This system is solved numerically by inversion of the matrix of the Laplacian at the calculation points 22, taking into account the boundary conditions.

We thus obtain the velocity vector of the wind \vec{V} 10 at the calculation points 22 of the volume of interest. The values of \vec{V} vertically above the lidar 1, i.e. along the axis of the altitudes Z and in its vicinity, are used for determining the profile of the wind as a function of the altitude under the best possible accuracy conditions.

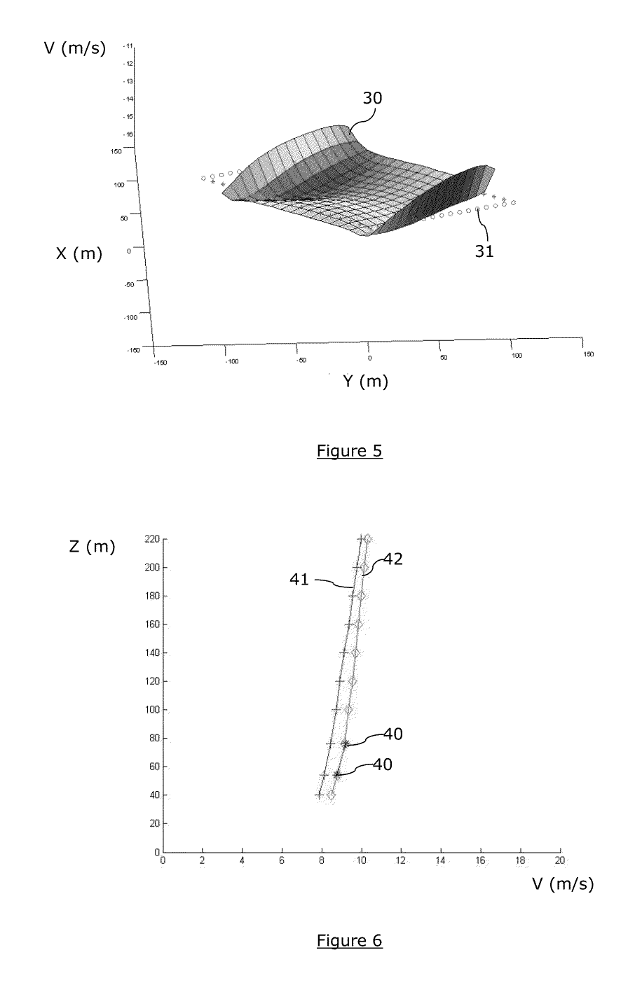

FIG. 5 shows an example of a result of calculation of wind velocity at a given altitude Zₕ. The surface 30 is representative of the amplitude of the horizontal component of the velocity vector of the wind 10 in a plane (X, Y, Z=Zₕ), calculated from the boundary conditions 31.

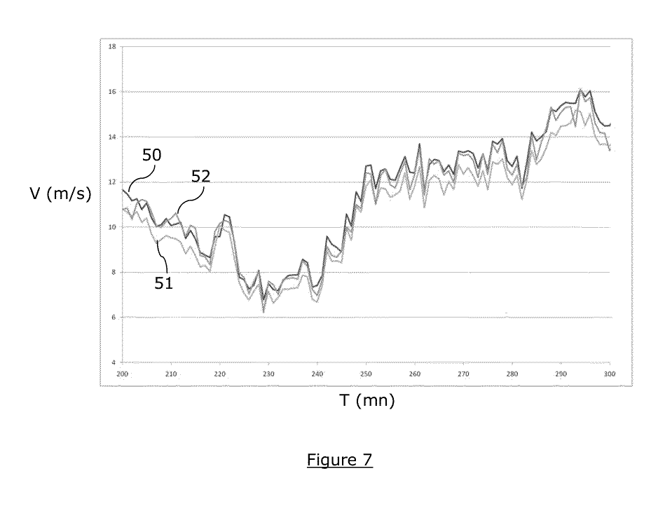

FIG. 6 gives an example of a result of calculation of wind velocity as a function of the altitude Z (vertical profile). The measurements were performed respectively with two reference cup anemometers (points 40), a lidar implementing a model of geometric reconstruction using the hypothesis of homogeneity (curve 41) and a lidar using the method according to the invention based on the model of the perfect fluid (curve 42). Results that are much closer to those of the cup anemometers (40) are obtained with the lidar using the method according to the invention (42).

FIG. 7 shows the results of 16 hours of measurements of wind velocities obtained during a measurement campaign carried out on undulating terrain. The measurements were carried out at an altitude of about 80 metres, respectively with a reference cup anemometer (curve 50), a lidar using a model of geometric reconstruction using the hypothesis of homogeneity (curve 51) and a lidar using the method according to the invention based on the model of the perfect fluid (curve 52).

The relative error of the lidar versus the cup anemometer is about 6% using the geometric model for calculating the wind, and about 2% using the method according to the invention and the model of the perfect fluid.

According to a variant in which the equations of the mechanical behaviour model of the fluid are solved by an iterative method, initial conditions are defined also by assigning the value \vec{V}ₕ previously calculated for defining the boundary conditions at points 22 of the grid 20 located at an altitude Z=Zₕ in the volume of interest, and this operation is performed for all the altitudes Z, directly or by interpolation between calculated values of \vec{V}ₕ.

According to another variant, a priori knowledge of the topology of the terrain is used as an additional boundary condition in order to improve the accuracy of the calculation. In this case, the zone of interest is extended so as to include the relief of the terrain, and an additional boundary condition such that, for example, the velocity vector of the wind \vec{V} is tangential to the surface of the terrain, is applied to the points 23 of the grid 20 that are located on the surface of the terrain.

Of course, the invention is not limited to the examples which have just been described and numerous adjustments can be made to these examples without exceeding the scope of the invention.

1. A method for determining the flow of a fluid in a volume of interest, comprising:
remote measurement, at a plurality of measurement points distributed along at least three measurement axes with different spatial orientations passing through the volume of interest, of the radial velocity of said fluid in the vicinity of said measurement points;
calculation of the velocity of the fluid at a plurality of calculation points distributed as a grid in the volume of interest; and
wherein the calculation of the velocity of the fluid comprises the use of a mechanical behaviour model of said fluid.

2. The method according to claim 1, characterized in that the measurement of radial velocity of the fluid comprises a measurement of Doppler frequency shifts of waves previously transmitted and scattered in the fluid.

3. The method according to claim 1, characterized in that it further comprises a step of calculating initialization conditions, comprising a calculation of the velocity of the fluid at calculation points from measures of radial velocities, using a geometric model based on the hypothesis that the velocity of the fluid in the volume of interest is substantially homogeneous in layers of substantially parallel orientation through which the measurement axes pass, said calculation of initialization conditions comprising at least one of:
a calculation of boundary conditions comprising a calculation of conditions that are limiting for the velocity of the fluid at calculation points located at the periphery of the volume of interest, and
a calculation of initial conditions comprising a calculation of the velocity of the fluid at calculation points located in the volume of interest.

4. The method according to claim 3, characterized in that it further comprises a step of calculating initialization conditions using the topology of a material surface present in or at the periphery of the volume of interest and limiting the extension of the fluid, comprising:
a determination of calculation points of the volume of interest located outside of the fluid and/or in the vicinity of said material surface, and
attribution of conditions that are limiting for the velocity to said defined calculation points.

5. The method according to claim 3, characterized in that it further comprises a step of calculating the velocity of the fluid in the volume of interest, by solving the equations of the mechanical behaviour model of the fluid, using the previously calculated initialization conditions.

6. The method according to claim 5, characterized in that the mechanical behaviour model of the fluid comprises any one of the following sets of hypotheses:
the fluid comprises an incompressible Newtonian fluid and its flow is described approximately by the Navier-Stokes equations, or
the fluid comprises a perfect fluid and its flow is described approximately by the Euler equation of fluids.

7. The method according to claim 6, characterized in that with \vec{V} denoting the velocity vector of the fluid, v the kinematic viscosity of the fluid, ρ the density of the fluid, \vec{f} the resultant of the body forces exerted in the fluid and p the pressure of the fluid, the flow of said fluid is described by any one of the systems of equations:
$$\begin{matrix}- \{ \begin{matrix}\vec{∇} \cdot \vec{V} = 0 \\ \frac{\partial \vec{V}}{\partial t} - v {∇}^{2} \vec{V} + ( \vec{V} \cdot \vec{∇} ) \vec{V} + \frac{1}{ρ} \vec{∇} p = \vec{f} ;\end{matrix} \\ - \{ \begin{matrix}\vec{∇} \cdot \vec{V} = 0 \\ - v {∇}^{2} \vec{V} + ( \vec{V} \cdot \vec{∇} ) \vec{V} + \frac{1}{ρ} \vec{∇} p = \vec{0} ;\end{matrix} \\ - \{ \begin{matrix}\vec{∇} \cdot \vec{V} = 0 \\ ( \vec{V} \cdot \vec{∇} ) \vec{V} + \frac{1}{ρ} \vec{∇} p = \vec{0} ;\end{matrix} \\ - \vec{∇} \cdot \vec{V} = 0.\end{matrix}$$

8. The method according to claim 7, characterized in that the equations of the mechanical behaviour model of the fluid are solved numerically at the calculation points of the volume of interest by an iterative method.

9. The method according to claim 8, characterized in that solving the equations of the mechanical behaviour model comprises the use of conditioning matrices.

10. The method according to claim 5, characterized in that the mechanical behaviour model of the fluid comprises the hypotheses that the fluid comprises a perfect fluid, the flow of which is approximately irrotational in the volume of interest.

11. The method according to claim 10, characterized in that with \vec{V} denoting the velocity vector of the fluid and P a velocity potential, the flow of said fluid is described by the system of equations:
$$\{ \begin{matrix}{∇}^{2} P = 0 \\ \vec{V} = - \vec{∇} P\end{matrix}$$

12. The method according to claim 11, characterized in that the equations of the mechanical behaviour model of the fluid are solved numerically at the calculation points of the volume of interest by inversion of the matrix of the Laplacian.

13. The method according to claim 5, characterized in that it further comprises steps of:
calculating new initialization conditions from the velocity of the fluid previously calculated in the volume of interest by solving the equations of the mechanical behaviour model of the fluid,
calculating the velocity of the fluid in the volume of interest, by solving the equations of the mechanical behaviour model of the fluid, using said new initialization conditions.

14. The method according to claim 1, further including at least one preliminary sequence of measuring radial velocities and of calculating the velocity of the fluid in the volume of interest, and in that the calculation of the velocity of the fluid in the volume of interest comprises the use of a dynamic mechanical behaviour model of the fluid, and the use of velocities of the fluid calculated during said preliminary sequence or sequences.

15. The method according to claim 1, characterized in that it is implemented for measuring the wind in the lower layers of the atmosphere.

16. A device for determining the flow of a fluid in a volume of interest implementing the method according to any one of the preceding claims, comprising:
means for remote measurement, at a plurality of measurement points distributed along at least three measurement axes with different spatial orientations passing through the volume of interest, of the radial velocity of said fluid in the vicinity of said measurement points;
means for calculation of the velocity of the fluid at a plurality of calculation points distributed as a grid in the volume of interest; and
said means for calculation of the velocity of the fluid are arranged for implementing a mechanical behaviour model of said fluid.

17. The device according to claim 16, characterized in that it further comprises any one of the following devices: lidar, radar, sodar.
